(19) United States
(12) Patent Application Publication
(10) Pub. No.: US 2025/0305640 A1
(43) Pub. Date: Oct. 2, 2025

(54) PRESSURE VESSEL

(71) Applicant: Eaton Intelligent Power Limited, Dublin 4 (IE)

(72) Inventors: Richard Keith Pemberton, Columbia, MD (US); William D. Siska, Marilla, NY (US)

(21) Appl. No.: 19/094,084

(22) Filed: Mar. 28, 2025

Related U.S. Application Data
(60) Provisional application No. 63/571,195, filed on Mar. 28, 2024.

(51) Int. Cl. F17C 13/08; F17C 1/16

(52) U.S. Cl. CPC F17C 13/084; F17C 1/16; F17C 2201/0109; F17C 2203/0604; F17C 2203/0621; F17C 2203/0673; F17C 2205/0165; F17C 2223/035

(57) ABSTRACT

A pressure vessel is disclosed, comprising a pressure vessel body defining interior for containing a pressurized fluid and an accessory attachment structure coupled to the pressure vessel body. The pressure vessel body comprises a liner and at least a first layer that surrounds the liner, the first layer including a fiber-reinforced polymer. The accessory attachment structure comprises an accessory connection portion and an anchor portion. The anchor portion is secured between the liner and the first layer with the first layer overlapping the anchor portion. The accessory connection portion projects outwardly from the anchor portion at least partially through the first layer.

### CROSS-REFERENCE TO RELATED APPLICATIONS

This application claims the benefit of U.S. Provisional Patent Application No. 63/571,195, filed Mar. 28, 2024. The disclosure of the priority application in its entirety is hereby incorporated by reference into the presence application.

### BACKGROUND

Pressure vessels represent a cornerstone technology across numerous industrial sectors, serving critical roles in applications ranging from life saving equipment like Self-Contained Breathing Apparatus to the storage and transportation of volatile substances such as fuel. Additionally, these vessels play pivotal roles in cutting-edge aerospace endeavors, finding utility in spacecraft propulsion systems and life support mechanisms. The versatility and reliability of pressure vessels make them indispensable assets in ensuring safety, efficiency, and performance across a broad spectrum of industrial operations. Thus, ongoing research in pressure vessel design and fabrication remains imperative to meet evolving demands for enhanced functionality, durability, and safety in various industrial settings.

### SUMMARY

In general terms, this disclosure is directed to solutions that preserve the integrity of rounded vessel shapes while providing secure and durable attachment interfaces for various accessories and add-ons.

One aspect is a pressure vessel comprising a pressure vessel body defining interior for containing a pressurized gas and/or fluid, the pressure vessel body including a liner and at least a first layer that surrounds the liner, the first layer including a fiber-reinforced polymer; and an accessory attachment structure coupled to the pressure vessel body, the accessory attachment structure including an accessory connection portion and an anchor portion, the anchor portion being secured between the liner and the first layer with the first layer overlapping the anchor portion, the accessory connection portion projecting outwardly from the anchor portion at least partially through the first layer.

### BRIEF DESCRIPTION OF THE DRAWINGS

Non-limiting embodiments of the present disclosure will be described by way of example with reference to the accompanying figures, which are schematic and are not intended to be drawn to scale. For purposes of clarity, not every component is labeled in every figure, nor is every component of each embodiment of the present disclosure shown where illustration is not necessary to allow those of ordinary skill in the art to understand the teachings of the present disclosure. In the figures:

FIG. 1 is a perspective view of an example embodiment of a pressure vessel according to the present disclosure.

FIG. 2 is another perspective view of an example embodiment of a pressure vessel shown in FIG. 1.

FIG. 3 is a front view of an example embodiment of a pressure vessel shown in FIG. 1.

FIG. 4 is a top view of an example embodiment of a pressure vessel shown in FIG. 1.

FIG. 5 is a left view of an example embodiment of a pressure vessel shown in FIG. 1.

FIG. 6 is a right view of an example embodiment of a pressure vessel shown in FIG. 1.

FIG. 7 is a right, cross-section view of an example embodiment of a pressure vessel shown in FIG. 1.

FIG. 8 is a front, cross-section view of an example embodiment of a pressure vessel shown in FIG. 1.

FIG. 9 is a schematic view of an example embodiment of a pressure vessel shown in FIG. 1, showing a tow being wrapped around the liner.

FIG. 10 is an enlarged view of an example embodiment of a pressure vessel, showing an accessory attachment structure with a bolt attached.

FIG. 11 is an enlarged view of an example embodiment of a pressure vessel, showing an accessory attachment structure without any accessories.

FIG. 12 is an enlarged view of another example embodiment of a pressure vessel, showing an accessory attachment structure without any accessories.

FIG. 13 is a schematic view of an example embodiment of an accessory attachment structure shown in FIG. 12.

FIG. 14 is a perspective view of a further example embodiment of an accessory attachment structure with a ball latch unattached.

FIG. 15 is a schematic view of an example embodiment of an accessory attachment structure shown in FIG. 14.

FIG. 16 is an enlarged view of an example embodiment of a pressure vessel, showing an accessory attachment structure with a rigid handle accessory attached.

FIG. 17 is an enlarged view of an example embodiment of a pressure vessel, showing an accessory attachment structure with a flexible handle accessory attached.

FIG. 18 is an enlarged view of an example embodiment of a pressure vessel, showing an accessory attachment structure with a bracket accessory attached.

FIG. 19 is an enlarged view of an example embodiment of a pressure vessel, showing an accessory attachment structure with a lanyard accessory attached.

FIG. 20 is an enlarged view of an example embodiment of a pressure vessel, showing an accessory attachment structure with a laser accessory attached.

FIG. 21 is an enlarged view of an example embodiment of a pressure vessel, showing an accessory attachment structure with a container accessory attached.

FIG. 22 is an enlarged view of an example embodiment of a pressure vessel, showing an accessory attachment structure with a streamer accessory attached.

FIG. 23 is an enlarged view of an example embodiment of a pressure vessel, showing an accessory attachment structure with a molded base accessory attached.

FIG. 24 is an enlarged view of an example embodiment of a pressure vessel, showing an accessory attachment structure with a strap accessory attached.

FIG. 25 is a front view of an example embodiment of a pressure vessel, showing a strap accessory in FIG. 24.

FIG. 26 is an enlarged view of an example embodiment of a pressure vessel, showing an accessory attachment structure with a RFID accessory attached.

FIG. 27 is an enlarged view of an example embodiment of a pressure vessel, showing an accessory attachment structure with a light accessory attached.

FIG. 28 is a schematic view of an example embodiment of a Self-Contained Breathing Apparatus with a light accessory attached.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

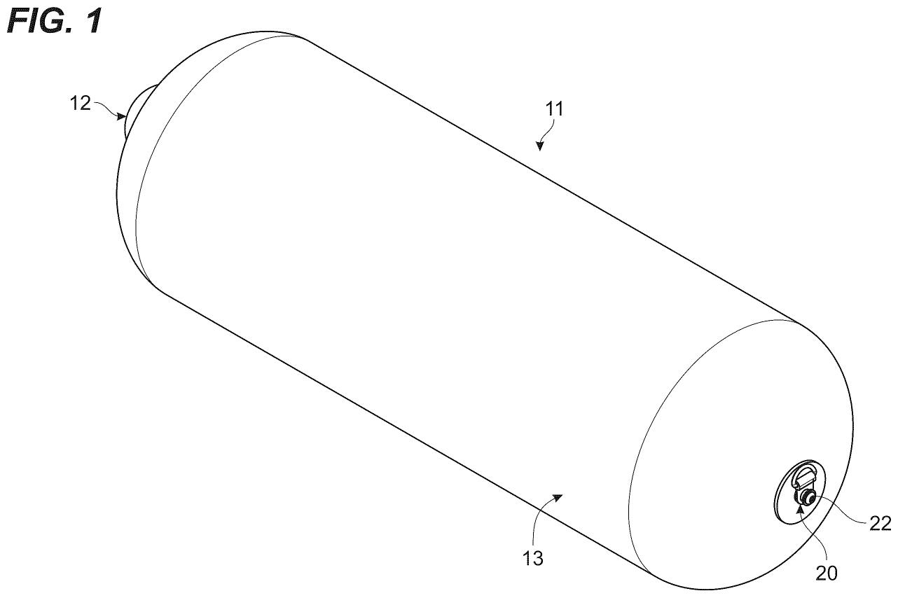

FIGS. 1-6 illustrate an example embodiment of a pressure vessel 11. In the realm of high-pressure vessel design, the incorporation of rounded shapes, as shown in FIGS. 1-6, presents a notable challenge in facilitating permanent accessory attachment structure 20 for attaching accessories or supplementary components. The inherent curvature of the vessel inhibits the seamless integration of such accessory attachment structure without compromising the structural integrity and aesthetic appeal of the overall form. Potential attachment methods impose stress points or alter the smooth contours of the container, detracting from its intended design and functionality. Addressing this challenge is essential for advancing the versatility and usability of containers across diverse applications and industries.

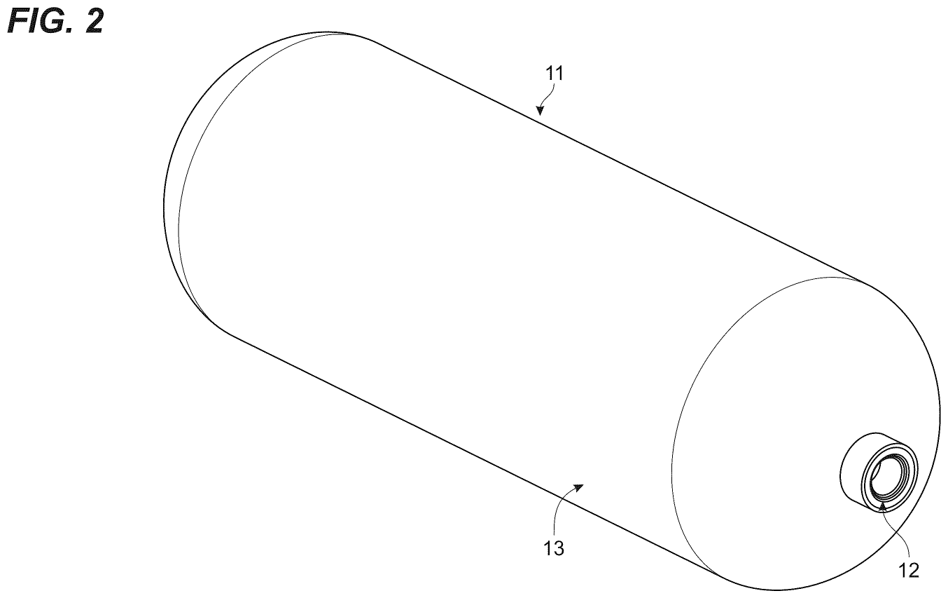

FIG. 1 is a perspective view of an example embodiment of a pressure vessel 11 according to the present disclosure. FIG. 2 is another perspective view of an example embodiment of a pressure vessel 11 shown in FIG. 1. In the illustrated example, an example pressure vessel 11 includes a neck 12, a pressure vessel body 13, and an accessory attachment structure 20. The example pressure vessel is rated to accommodate an internal fluid pressure of at least 5,000 pounds per square inch. In other embodiments, the pressure vessel is rated to accommodate an internal fluid pressure of at least 7,500 pounds per square inch. In further embodiments, the pressure vessel is rated to accommodate an internal fluid pressure of at least 10,000 pounds per square inch, which is further described below.

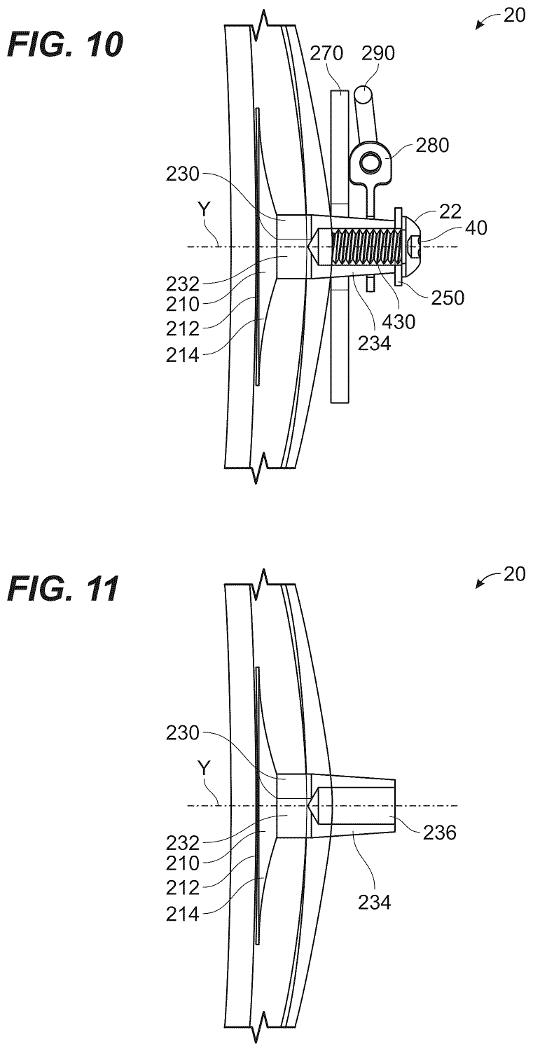

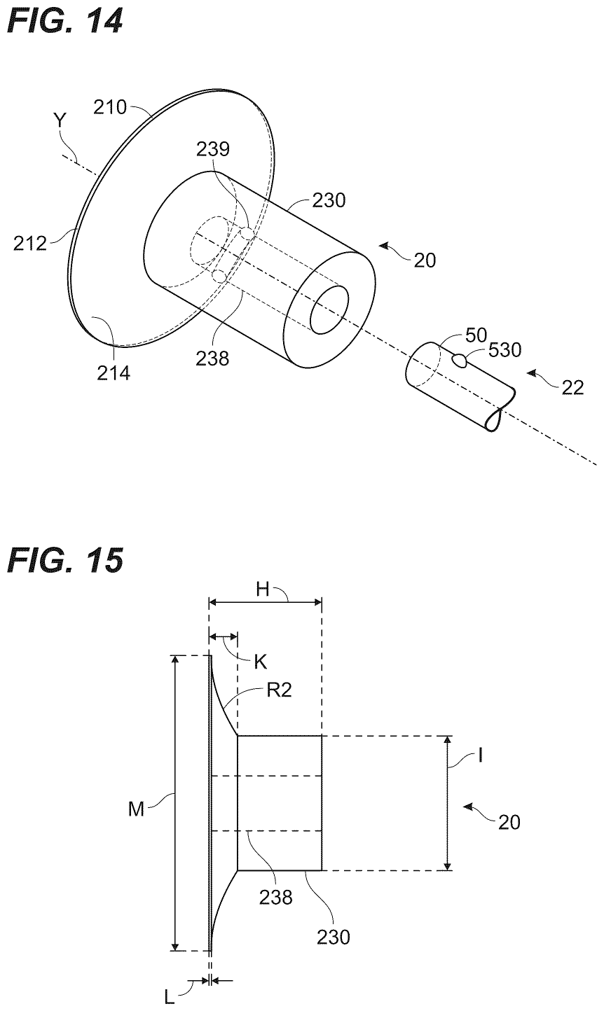

In some embodiments, the pressure vessel 11 further includes an accessory 22 attached to the accessory attachment structure 20. The accessory 22 can be detachably connected or permanently connected to the accessory attachment structure 20. The permanent connection can be a unitary connection (e.g., the accessory can be one-piece with the accessory connection portion). The detachable connection can include mechanical connection interfaces that detachably engage each other (e.g., mate, interlock, etc.). Example interfaces include threaded interfaces, snap-fit interfaces, magnets and other interfaces. Using specific accessory attachment structure 20 for the pressure vessel 11, such as a threaded interface seen in FIGS. 10-13 and a snap-fit interface seen in FIGS. 14-15, can help attach the accessory 22 to the pressure vessel body 13.

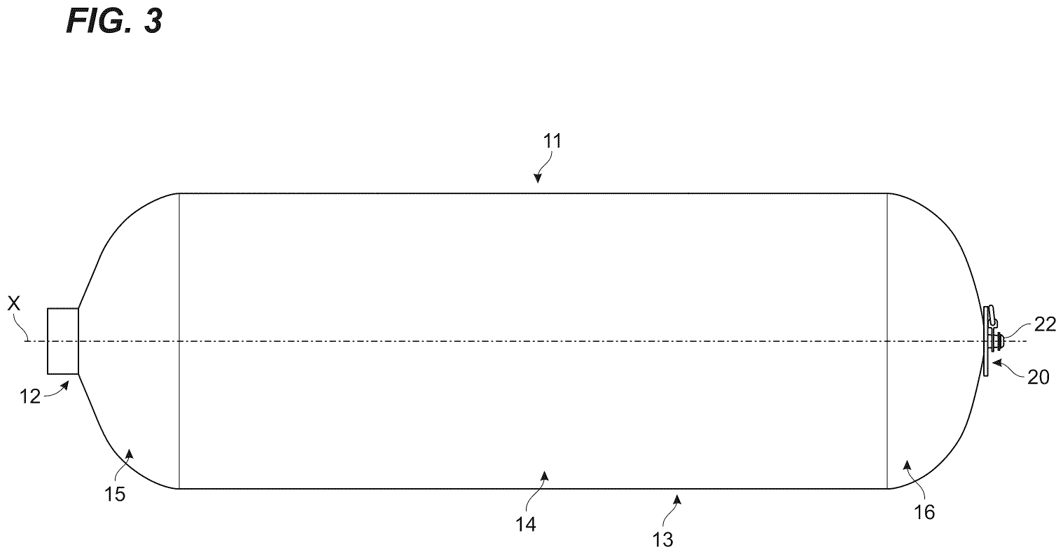

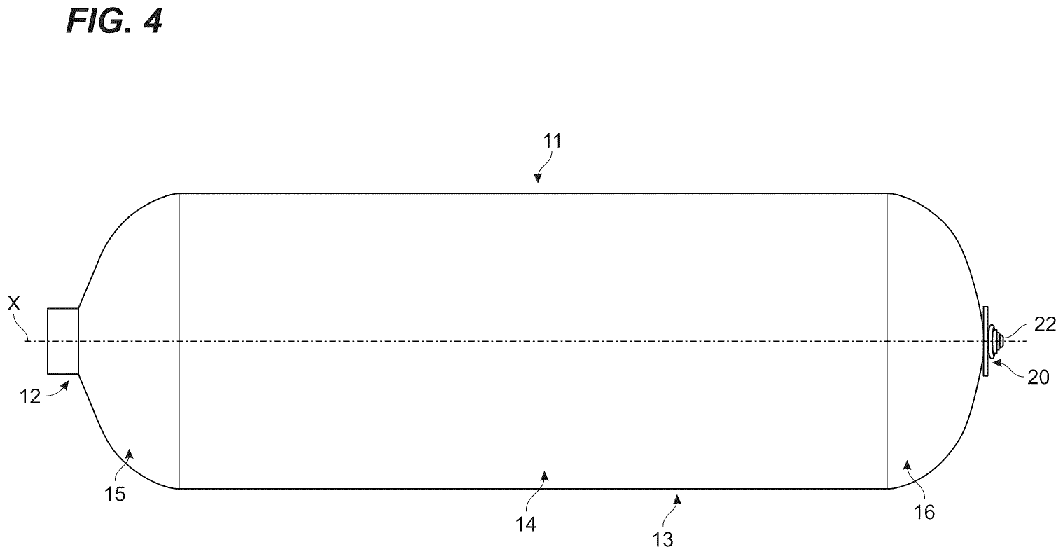

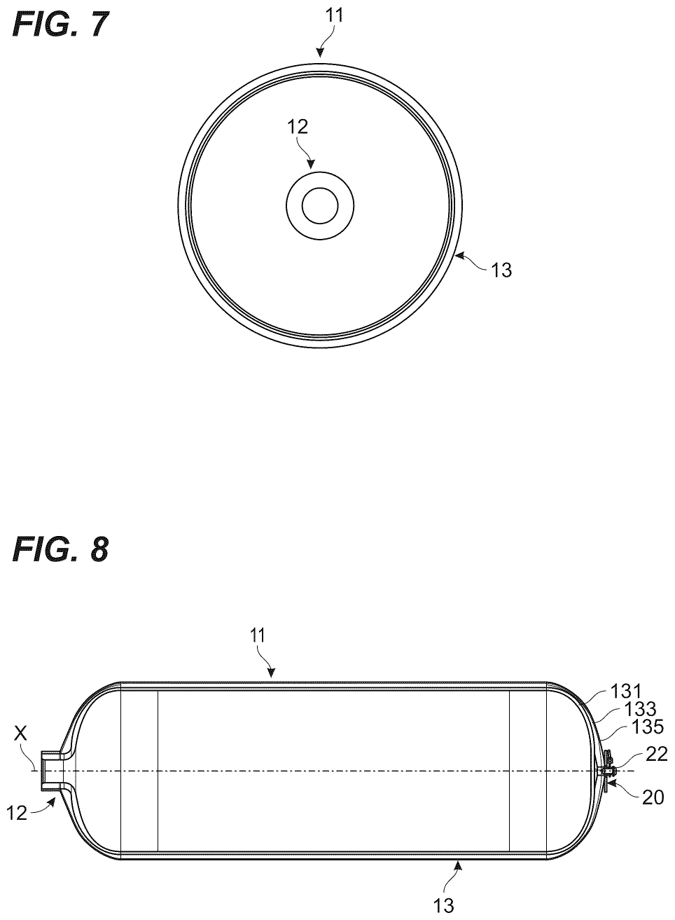

FIG. 3 is a front view of an example embodiment of a pressure vessel 11 shown in FIG. 1. FIG. 4 is a top view of an example embodiment of a pressure vessel 11 shown in FIG. 1. As described above, the example pressure vessel 11 includes a neck 12, a pressure vessel body 13, and an accessory attachment structure 20. The pressure vessel body 13 extends longitudinally along a pressure vessel axis X and has a substantially mirrored shape on opposite sides of the pressure vessel axis X. The pressure vessel body 13 includes a cylindrical main body 14, a first end 15, and a second end 16. The first and second ends 15 and 16 are located on opposite sides of the main body 14 along the pressure vessel axis X. The structure of the pressure vessel body 13 is explained in more detail in the context of FIGS. 7-9. The neck 12 is coupled to the first end 15 and the accessory attachment structure 20 is coupled to the second end 16. At least one of the first and second ends 15 and 16 is rounded shape, for example, the first end 16 where the accessory attachment structure 20 is coupled to is rounded dome shape.

In some embodiments, the pressure vessel body 13 is elongate along a pressure vessel axis X and extends along the pressure vessel axis X from a first end 15 to a second end 16, the pressure vessel body 13 includes a cylindrical main body 14 that extends between the first and second ends 15 and 16, the first end 15 includes a neck 12 defining a tank port and the second end 16 has a rounded dome shape, and the accessory attachment structure 20 is anchored to the pressure vessel body 13 at the second end 16 of the pressure vessel body 13.

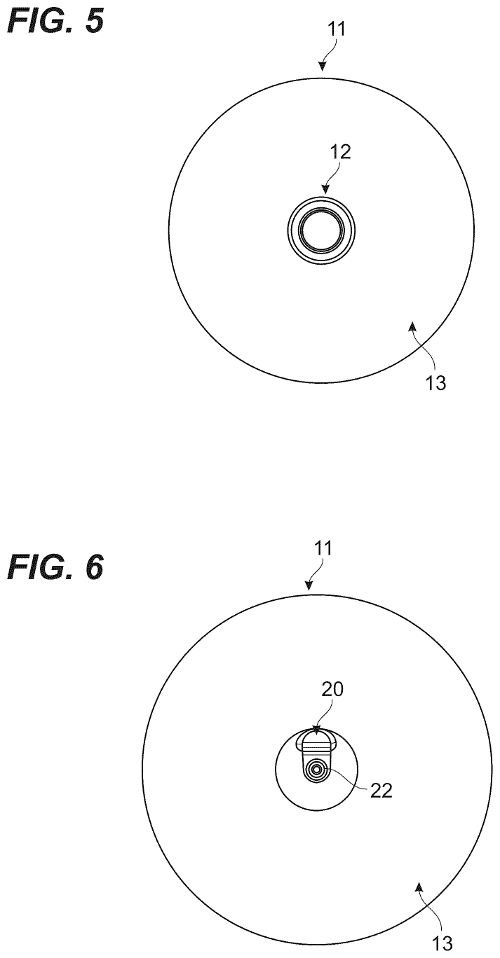

FIG. 5 is a left view of an example embodiment of a pressure vessel 11, showing the neck 12. The neck 12 is in fluid communication with external components, for example, a liquid conduit or a gas conduit. In the example embodiment of the pressure vessel 11 being a Self-Contained Breathing Apparatus, the neck 12 can include an oxygen outlet connecting to a detachably mounted plug. The axis of the neck 12 is concentric with the pressure vessel axis X.

FIG. 6 is a right view of an example embodiment of a pressure vessel 11 shown in FIG. 1. Using specific accessory attachment structure 20 for the pressure vessel 11, such as a threaded interface seen in FIGS. 10-13 and a snap-fit interface seen in FIGS. 14-15, can help attach the accessory 22 to the pressure vessel body 13. There are examples provided in FIGS. 10, 14, and 16-28 that illustrate and describe the accessory 22 configured to be attached to the pressure vessel 11.

FIGS. 7-8 illustrated an example embodiment of a pressure vessel 11 showing a detailed structure of a pressure vessel body 13. FIG. 7 is a right, cross-section view of an example embodiment of a pressure vessel 11 shown in FIG. 1. FIG. 8 is a front, cross-section view of an example embodiment of a pressure vessel 11 shown in FIG. 1. The example pressure vessel body 13 includes a liner 131, and a first layer 133. In some embodiments, the example pressure vessel body 13 further includes a second layer 135. A pressure vessel 11 can include a pressure vessel body 13 defining interior for containing a pressurized fluid, the pressure vessel body includes a liner 131 and at least a first layer 133 that surrounds the liner 131, the first layer 131 includes a fiber-reinforced polymer; and an accessory attachment structure 20 coupled to the pressure vessel body 13, the accessory attachment structure 20 includes an accessory connection portion 230 and an anchor portion 210, the anchor portion 210 is secured between the liner 131 and the first layer 133 with the first layer 133 overlapping the anchor portion 210, the accessory connection portion 230 projects outwardly from the anchor portion 210 at least partially through the first layer 133.

The example liner 131 can be formed from metal or plastic. A liner 131 formed from metal comprises a metal selected from the group consisting of transition metals, lanthanide metals, actinide metals, aluminum, gallium, indium, silicon, germanium, tin, lead, arsenic, antimony, bismuth, selenium, titanium, copper and tellurium. And all possible alloys including but not limited to brass alloys, steel alloys, nickel alloys, titanium alloys and aluminum alloys. In some embodiments, the liner 131 comprises alumni. In another embodiment, the liner 131 comprises stainless steel. The liner 131 can be formed from plastic, rubber or nylon. Plastic, rubber or nylon removes the problem of corrosion associated with metal liners.

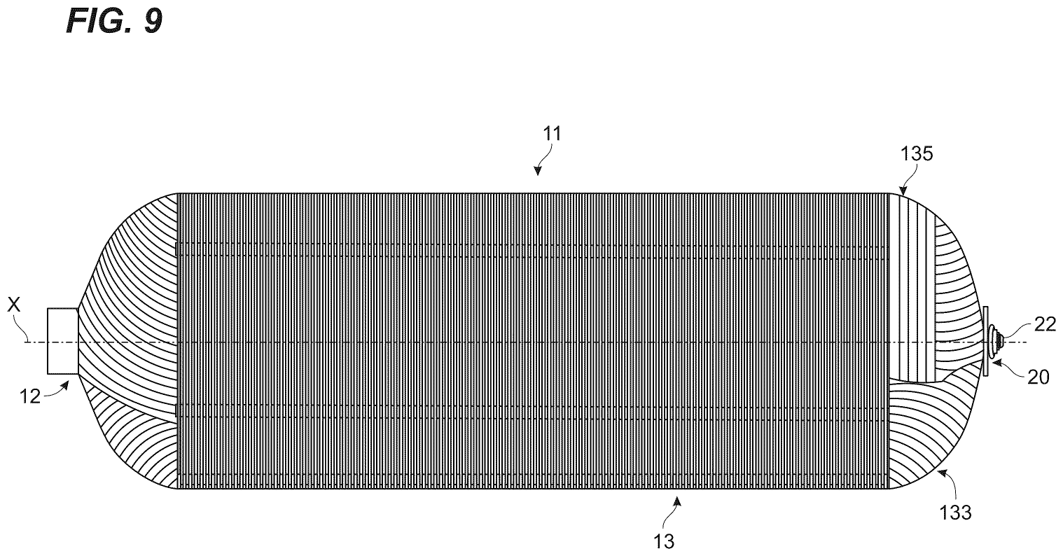

FIG. 9 is a schematic view of an example embodiment of a pressure vessel 11 shown in FIG. 1, showing a tow being wrapped around the liner 131. Here, an example first layer 133 is wound over the liner 131. The example first layer 133 can be formed by a composite overwrap, for example, a fiber tow. In some embodiments, the first layer 131 includes a fiber-reinforced polymer. In some embodiments, the first layer 133 is formed by a first resin-impregnated fiber-reinforced tow, the first resin-impregnated fiber-reinforced tow being wrapped around the liner 131 and over at least part of the surface of the accessory attachment structure 20. The example second resin-impregnated fiber-reinforced tow includes fiberglass or carbon fibers. In some embodiments, one of the first and second layers 133 and 135 includes fiberglass, aramid fiber (such as Kevlar), basalt, or other high strength fiber reinforcement either tow, tape, sheet, yarn or filament and the other of the first and second layers 133 and 135 includes carbon fibers. In some embodiments, the first layer 133 is formed by a first resin-impregnated fiber-reinforced tow, the first resin-impregnated fiber-reinforced tow being wrapped in a longitudinal orientation around the first and second ends 15 and 16 of the pressure vessel body 13, the first resin-impregnated fiber-reinforced tow extends over the liner 131 and over at least part of the surface of the accessory attachment structure 20 such that the accessory attachment structure 20 is secured between the liner 131 and the first resin-impregnated fiber-reinforced tow. The example first resin-impregnated fiber-reinforced tow includes fiberglass or carbon fibers. The first resin-impregnated fiber-reinforced tow can be a continuous-roving, pre-impregnated tow, meaning the fibers have been previously impregnated in an epoxy-bath with epoxy which will begin its cure process with the introduction of heat and/or light. The first layer 133 can also be comprised of a carbon composite thread. The first layer 133 could be used on the pressure vessel 11 to strengthen and protect these vessels. The containment overwrap layer 133 should also allow the exterior surface of the cylindrical main body 14 of the pressure vessel body 13 to maintain a pristine quality for an extended number of years. In some embodiments, the pressure vessel body 13 includes a second layer 135 formed by a second resin-impregnated fiber-reinforced tow, the second resin-impregnated fiber-reinforced tow being wrapped over the first layer 133 and over the anchor portion 210 of the accessory attachment structure 20.

FIGS. 10-15 illustrate different interfaces of the accessory attachment structure 20 for the pressure vessel 11. The example accessory attachment structure 20 includes an anchor portion 210 and an accessory connection portion 230, the anchor portion 210 being secured between the liner 131 and the first layer 133 with the first layer 133 overlapping the anchor portion 210. Thus, the first resin-impregnated fiber-reinforced tow can be wrapped over the anchor portion 210 of the accessory attachment structure 20, and the second resin-impregnated fiber-reinforced tow can be wrapped over the anchor portion 210 of the accessory attachment structure 20. The anchor portion 210 can be designed to be thin and round, for example, shaped as a flange.

The accessory connection portion 230 of the accessory attachment structure 20 extends along an accessory connection axis Y, the accessory connection portion 230 of the accessory attachment structure 20 has a base end coupled to the anchor portion 210 and the accessory connection portion 230 projects axially outwardly from the anchor portion 210. In some embodiments, the accessory connection axis Y is concentric with the pressure vessel axis X. In some embodiments, the accessory connection portion 230 of the accessory attachment structure 20 extends along an accessory connection portion axis that aligns with the pressure vessel axis X, and the anchor portion 210 of the accessory attachment structure 20 is located at a base end of the accessory connection portion 230 and projects radially outwardly from the accessory connection portion 230. In one example, the anchor portion 210 of the accessory attachment structure 20 has a circular outer shape when viewed from an orientation along the accessory connection axis Y of the accessory connection portion 230 of the accessory attachment structure 20. In one example, the anchor portion 210 has a major outer cross-dimension (e.g., a major outer diameter; see F at FIG. 13 and M at FIG. 13) that is at least 1.5 times, or at least 2 times as large as a corresponding outer cross-dimension (see B at FIG. 13 and I at FIG. 15) of the accessory connection portion 230.

The anchor portion 210 of the accessory attachment structure 20 has a thickness measured in an orientation along the accessory connection axis Y of the accessory connection portion 230 of the accessory attachment structure 20, and the anchor portion 210 is tapered such that the thickness reduces as the anchor portion 210 extends radially away from the accessory connection axis Y of the accessory connection portion. In some examples, a length (see A at FIG. 13 and H at FIG. 15) of the accessory connection portion 230 measured along the accessory connection axis Y is at least 2, 3, 4 or 5 times as large as the maximum thickness (see D at FIG. 13 and K at FIG. 15) of the anchor portion 210 measured along the accessory connection axis Y. In certain examples, the maximum thickness of the anchor portion 210 measured along the accessory connection axis Y is less than or equal to 0.2 inches, or less than or equal to 0.15 inches, or less than or equal to 0.1 inch. In certain examples, a minimum thickness (see E at FIG. 13 and L at FIG. 15) of the anchor portion 210 measured along the accessory connection axis Y is less than or equal to 0.025 inches, or less than or equal to 0.02 inches, or less than or equal to 0.15 inches. In certain examples, a ratio of a maximum radial cross-dimension (see F at FIG. 13 and M at FIG. 15) of the accessory attachment structure 20 (e.g., the major diameter of the anchor portion 210) to a total length (see A at FIG. 13 and H at FIG. 15) of the accessory attachment structure 20 (e.g., measured along the accessory connection axis Y) is in the range of 0.8:1 to 3:1.

It will be appreciated that the dimensions of the accessory attachment structure can vary depending upon a variety of factors such as the size of the pressure vessel, the type of pressure vessel, the intended use of the pressure vessel and the type of accessory intended to be attached. In one example, for a pressure vessel having an outer diameter of about 6 inches at the cylindrical body portion, the accessory attachment structure can have: a length (see A at FIG. 13 and H at FIG. 15) in the range of 0.3-1.2 inches; a major cross-dimension at the anchor portion (see F at FIG. 13 and M at FIG. 15) in the range of 0.8-1.2 inches; and a minor cross-dimension (see B at FIG. 13 and I at FIG. 15) at the anchor portion in the range of 0.4-0.6 inches.

In some embodiments, the anchor portion 210 of the accessory attachment structure 20 is centered with respect to the pressure vessel axis X. In some embodiments, the anchor portion 210 of the accessory attachment structure 20 is centered with respect to the accessory connection axis Y of the accessory connection portion 230 of the accessory attachment structure 20. In some embodiments, the anchor portion 210 of the accessory attachment structure 20 has a circular outer shape when viewed from an orientation along the accessory connection axis Y of the accessory connection portion of the accessory attachment structure. In some embodiments, the anchor portion 210 of the accessory attachment structure 20 has a thickness measured in an orientation along the accessory connection axis Y of the accessory connection portion 230 of the accessory attachment structure 20, and the anchor portion 210 is tapered such that the thickness reduces as the anchor portion 210 extends radially away from the accessory connection axis Y of the accessory connection portion 230. In some embodiments, the anchor portion 210 has a concave surface 211 that faces away from the liner 131 and curves as the concave surface 211 extends in a radial orientation outwardly from the minor outer diameter of the anchor portion 210 to the major outer diameter of the anchor portion 210. In some embodiments, the radius of curvature R1 of the concave surface 211 of the anchor portion 210 is in the range of 0.3-0.7 inches or in the range of 0.4-0.6 inches or less than 1 inch. In some embodiments, the major cross dimension (e.g., the major outer diameter) of the anchor portion 210 has a dimension that is 5%-30% or 5%-25% or 10%-20% as large as an outer cross dimension (e.g., the outer diameter) of the cylindrical main body 14 of the pressure vessel body 13. In one example, the concave surface 211 is annular when viewed from an orientation along the accessory connection axis Y. The anchor portion 210 includes a base surface 213 that faces toward the liner 13. In one example, the base surface 213 is planar.

FIGS. 10-13 show an example embodiment of an accessory attachment structure 20 for the pressure vessel 11, showing an accessory connection portion 230 with a female or inner thread 236. The example accessory attachment structure 20 includes an anchor portion 210 and an accessory connection portion 230, and the anchor portion 210 includes a first anchor portion 212 and a second anchor portion 214, the first anchor portion 212 has a constant outer cross-dimension (e.g., a constant outer diameter), and the second anchor portion 214 is tapered such that the outer cross-dimension (e.g., the outer diameter) increases and the axial thickness reduces as the anchor portion 210 extends axially along the accessory connection axis Y in a direction away from the accessory connection portion 230 and toward the liner 131. The tapered section of the second anchor portion 214 can include a concave surface that curves from the minor diameter at the accessory connection portion 230 to the major outer diameter of the anchor portion 210. It is understandable that while the accessory connection portion 230 includes a female or inner thread 236, the accessory 22 can include a mating male or outer thread, e.g., the bolt 40 with a male or outer thread 430 (shown in FIG. 10). In other examples, the accessory connection portion can include an outer thread and the accessory can include an inner thread.

FIGS. 10-11 show an example embodiment of an accessory attachment structure 20 for the pressure vessel 11, showing an accessory connection portion 230 with a variable outer diameter. FIG. 10 is an enlarged view of an example embodiment of a pressure vessel 11, showing an accessory attachment structure 20 with a bolt 40 attached. FIG. 11 is an enlarged view of an example embodiment of a pressure vessel 11, showing an accessory attachment structure 20 without any accessories. The example accessory connection portion 230, as shown in FIGS. 10-11, extends outward along the accessory connection axis Y from the anchor portion 210. The example accessory connection portion 230 includes a first connection part 232 with a constant outer diameter and a second connection part 234 with a gradually reduced outer diameter as the accessory connection portion 230 extends longitudinally away from the anchor portion 210. The female or inner thread 236 extends longitudinally along the accessory connection axis Y through the entire length of the second connection part 234, as shown in FIGS. 10-11, thus facilitating the manufacture of the accessory connection portion 230. However, based on the requirements of the accessories, the length of the female or inner thread 236 can be longer or shorter.

In some embodiments, the accessory 22 includes a bolt 40. In some embodiments, the accessory 22 further includes a washer 270, a holder 280, and a ring 290. The washer 270 is located between the holder 280 and the pressure vessel body 13 to prevent contact between the holder 280 and the ring 290 from the pressure vessel body 13, thus avoiding damage to the pressure vessel from accidental impacts. The ring 290 can be connected to external components, including accessories. The ring 290 also provides a handheld section for easy carrying of the pressure vessel. In some embodiments, the ring 290 includes a D-ring. The holder 280 provides linkage between the ring 290 and the second connection part 234, and the holder 280 can be rigidly or movably fixed to the second connection part 234. The example accessory 22 can further include a bolt washer 250. In addition, when the holder 280 is movably fixed to the second connection part 234, the bolt washer 250 can further maintain the position of the holder 280 on the second connection part 234 of the accessory connection portion 230.

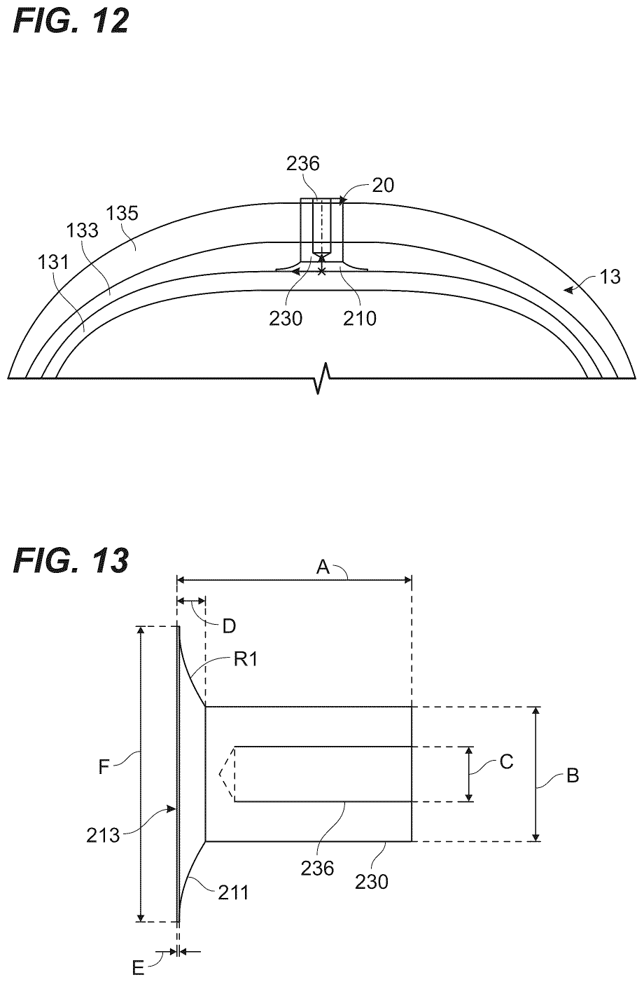

FIGS. 12-13 show an example embodiment of an accessory attachment structure 20 for the pressure vessel 11, showing an accessory connection portion 230 with a constant outer diameter. FIG. 12 is an enlarged view of another example embodiment of a pressure vessel 11, showing an accessory attachment structure 20 without any accessories. FIG. 13 is a schematic view of an example embodiment of an accessory attachment structure 20 shown in FIG. 12. The example accessory connection portion 230, as shown in FIGS. 12-13, extends outward along the accessory connection axis Y from the anchor portion 210. The example accessory connection portion 230 has a constant outer diameter as the accessory connection portion 230 extends longitudinally away from the anchor portion 210. The female or inner thread 236 extends longitudinally along the accessory connection axis Y through the accessory connection portion 230, as shown in FIG. 13, thus facilitating the manufacture of the accessory connection portion 230. However, based on the requirements of the accessories, the length of the female or inner thread 236 can be shorter to ensure the overall strength of the accessory connection portion 230. In some embodiments, the female or inner thread 236 does not extend through the entire length of the accessory connection portion 230. In one example, the diameter C of the female or inner thread 236 can be ⅜ inches and the number of threads per inch can be 16 or 24, which means it pertains to the common ⅜-16 bolt or ⅜-24 bolt with a male or outer thread.

FIGS. 14-15 show another example embodiment of an accessory attachment structure 20 for the pressure vessel 11. FIG. 14 is a perspective view of a further example embodiment of an accessory attachment structure 20 with a ball latch 50 unattached. FIG. 15 is a schematic view of an example embodiment of an accessory attachment structure 20 shown in FIG. 14. The example accessory connection portion 230, as shown in FIGS. 14-15, extends outward along the accessory connection axis Y from the anchor portion 210. The example accessory connection portion 230 has a constant outer diameter as the accessory connection portion 230 extends longitudinally away from the anchor portion 210, and the anchor portion 210 includes a first anchor portion 212 and a second anchor portion 214, the first anchor portion 212 has a constant cross-dimension (e.g., outer diameter), and the second anchor portion 214 is tapered such that the outer cross-dimension (outer diameter) increases and the axial thickness reduces as the anchor portion 210 extends axially away from the accessory connection portion 230. In some embodiments, the anchor portion 210 has a concave surface that curves from the minor diameter at the accessory connection portion 230 to the first anchor portion 212 adjacent the major outer diameter of the anchor portion 210. In some embodiments, the radius of curvature R2 of the concave surface of the anchor portion 210 is in the range of 0.4-0.6 inches. A latch bore 238 extends longitudinally along the accessory connection axis Y through the anchor portion 210 and the accessory connection portion 230, as shown in FIG. 15, thus facilitating the manufacture of the accessory attachment structure 20. However, based on the requirements of the accessories, the length of the latch bore 238 can be shorter. A ball hole 239 is located in the latch bore 238 and corresponds to a ball 530 of the ball latch 50. The ball hole 239 could be a circular hole that fits the outer shape of the ball 530, or it could be an annular recess that extends around the interior of the latch bore. When the ball latch 50 is fully inserted to the latch bore 238, the ball 530 of the ball latch 50 moves away from the accessory connection axis Y and toward the ball hole 239, and can be secured in the ball hole 239 to maintain the connection between the accessory attachment structure 20 and the accessory 22.

FIGS. 10, 14, and 16-28 illustrate and describe the accessory 22 configured to be attached to the pressure vessel 11. The example accessory 22 is detachably attached to the accessory connection portion 230 by a detachable mechanical connection, the detachable mechanical connection includes a first mechanical connection interface integrated with the accessory connection portion and a second mechanical connection interface 430, 530, 630, 730, 830, 930, 1030, 1130, 1230, 1330, 1430, 1530, 1630 integrated with the accessory 22, and the first and second mechanical connection interfaces are configured to be detachably connected together. The example accessory connection portion 230 of the accessory attachment structure 20 includes a first mechanical connection interface adapted for making a detachable connection with a second mechanical connection interface 430, 530, 630, 730, 830, 930, 1030, 1130, 1230, 1330, 1430, 1530, 1630 integrated with an accessory 22. Some examples of the first mechanical connection interface include a female or inner thread, a male or outer thread, or a snap-fit, as shown in FIGS. 10-15. In the examples of a female or male thread, the first mechanical connection interface includes first threads 236 and the second mechanical connection interface includes second threads 430 configured to mate with the first threads. In the examples of a snap-fit, the first mechanical connection interface includes a ball hole 239 or other recess and the second mechanical connection interface includes a ball 530 configured to mate with the ball hole 239 or other recess.

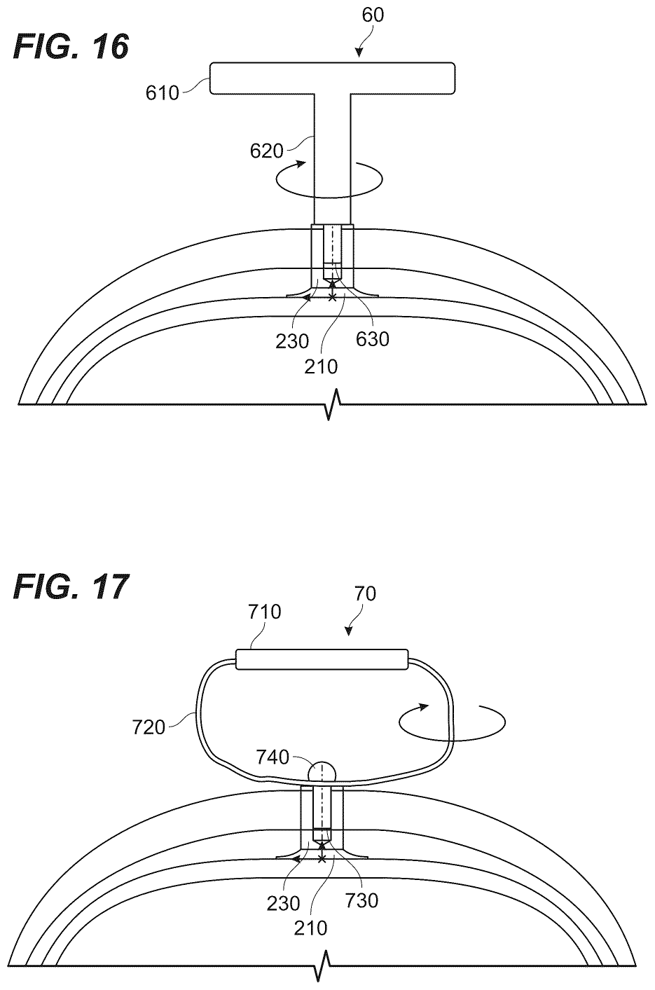

In FIGS. 16-17, the example accessory 22 is a handle. In FIG. 16, the example accessory 22 is a rigid handle 60. In FIG. 17, the example accessory 22 is a flexible handle 70. The rigid handle 60 includes a handheld portion 610, a handle linkage 620, and a second mechanical connection interface 630 which can be a thread or a snap-fit. The flexible handle 70 includes a handheld portion 710, a handle linkage 720, and a second mechanical connection interface 730 which can be a thread or a snap-fit. The handle linkage 720 can be coupled to the second mechanical connection interface 730 by an attach point 740 for the flexible handle 70.

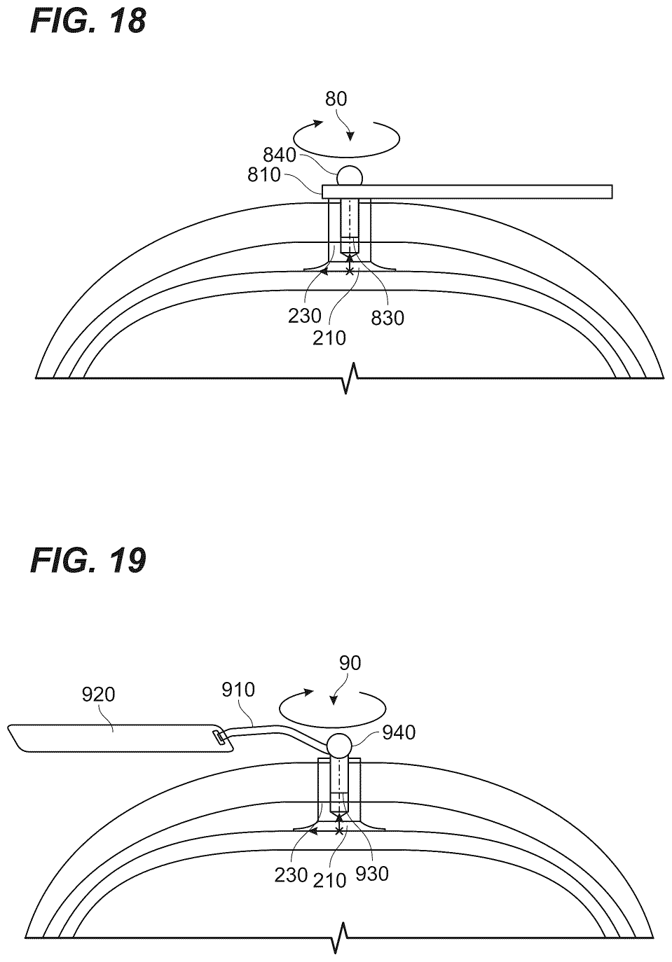

In FIGS. 18-28, the accessory can include a bracket 80, a lanyard 90, a laser device 100, a container 110, a streamer 120, a molded base 130, a strap 140, a radio- frequency identification (RFID) device 150, a light 160, and a combination thereof.

In FIG. 18, the example accessory 22 is a bracket 80. The bracket 80 includes a holder portion 810, and a second mechanical connection interface 830 which can be a thread or a snap-fit. The holder portion 810 can be coupled to the second mechanical connection interface 830 by an attach point 840 for a bracket 80.

In FIG. 19, the example accessory 22 is a lanyard 90. The lanyard 90 includes a lanyard portion 910, and a second mechanical connection interface 930 which can be a thread or a snap-fit. The lanyard portion 910 can be coupled to the second mechanical connection interface 930 by an attach point 940 for a lanyard. The lanyard 90 can further includes a tag 920 which is coupled to the lanyard portion 910.

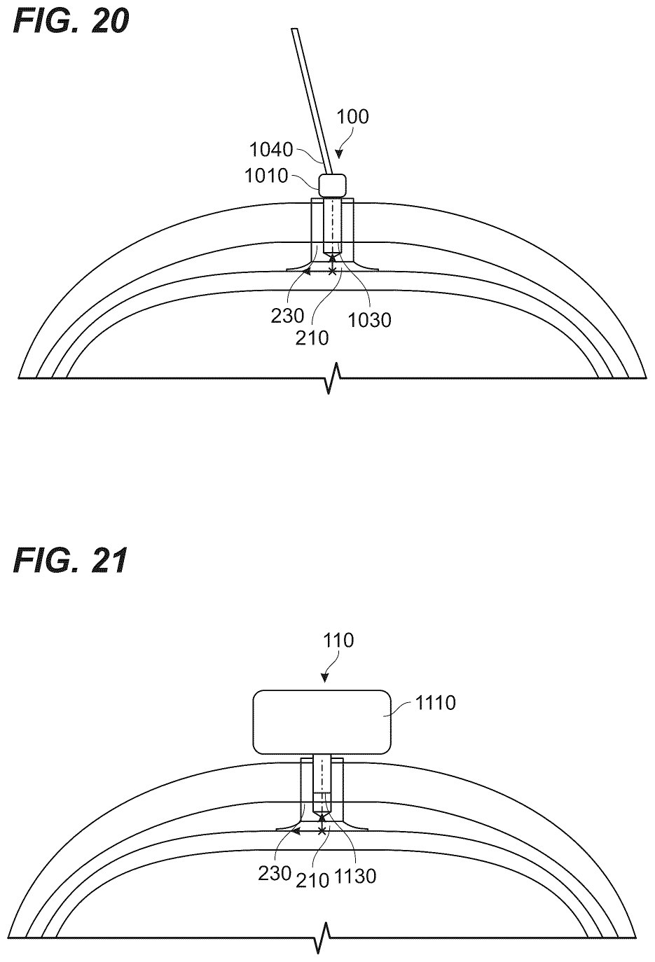

In FIG. 20, the example accessory 22 is a laser device 100. The laser device 100 includes a laser sensor 1010 for detecting the laser 1040, and a second mechanical connection interface 1030 which can be a thread or a snap-fit. The laser sensor 1010 can be coupled to the second mechanical connection interface 1030 directly or by other mechanical components. In some embodiments the laser device 100 can be activated by means of a switch, by means of a motion sensor, by means of a sound sensor, or even remotely using a remote control of some sort.

In FIG. 21, the example accessory 22 is a container 110. The container 110 includes a container portion 1110, and a second mechanical connection interface 1130 which can be a thread or a snap-fit. The container portion 1110 can be coupled to the second mechanical connection interface 1130 directly or by other mechanical components.

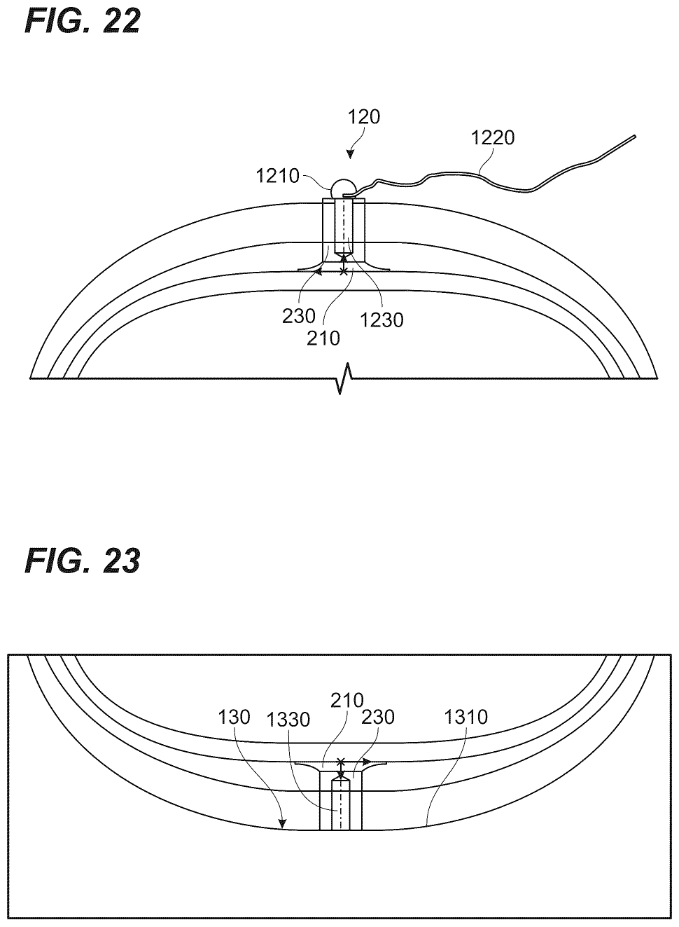

In FIG. 22, the example accessory 22 is a streamer 120. The streamer 120 includes an attach portion 1210 for a streamer, and a second mechanical connection interface 1230 which can be a thread or a snap-fit. The attach portion 1210 for a streamer can be coupled to the second mechanical connection interface 1230 directly or by other mechanical components. A streamer portion 1220 can be secured between the attach portion 1210 and the second mechanical connection interface 1230.

In FIG. 23, the example accessory 22 is a molded base 130. The molded base 130 includes a base portion 1310, and a second mechanical connection interface 1330 which can be a thread or a snap-fit. The base portion 1310 can be coupled to the second mechanical connection interface 1130 directly or by other mechanical components. In some embodiments, the external shape of the base portion 1310 at least partially fits the external shape of the pressure vessel body 13, and the accessory connection portion 230 extend within the pressure vessel body 13, e.g., through the first and second layers 133 and 135 without protruding from the external shape of the pressure vessel body 13. Example molded base 130 is shown with a flat bottom surface but it is clear that those skilled in the art will readily recognize the other sides of the molded base tother than 1310 may be of any shape advantageous to the user.

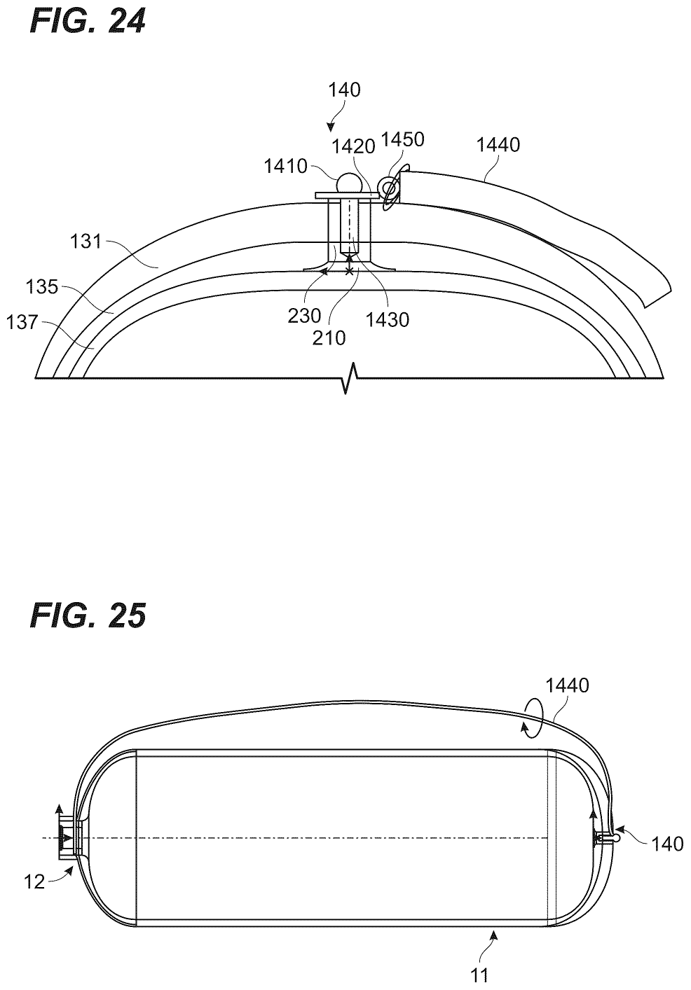

In FIGS. 24-25, the example accessory 22 is a strap 140. The strap 140 includes an attach portion 1410 for a strap, and a second mechanical connection interface 1430 which can be a thread or a snap-fit. The attach portion 1410 for a strap can be coupled to the second mechanical connection interface 1430 directly or by other mechanical components. A strap holder 1420 can be coupled between the attach portion 1410 and the second mechanical connection interface 1430. A first end of a strap portion 1440 can be coupled to the strap holder 1420 by a strap connector 1450 which can secure the rotation of the strap along the strap connector 1450, as shown in FIG. 25. A second end of a strap portion 1440 can be coupled to the neck 12, thus facilitating the portability of pressure vessel 11, rendering it convenient to move, transport, or carry.

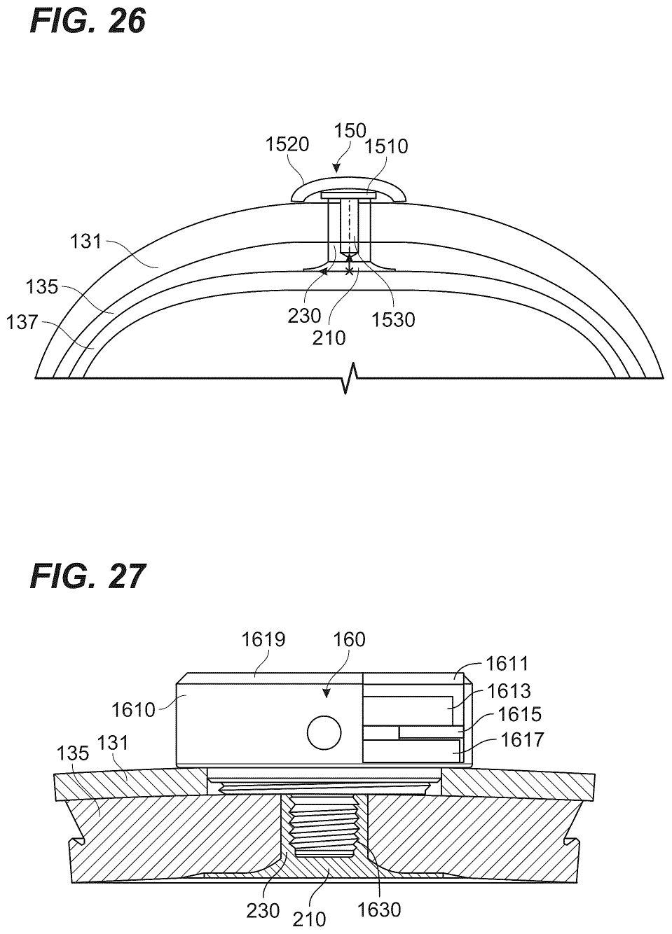

In FIG. 26, the example accessory 22 is a radio-frequency identification (RFID) device 150. The radio-frequency identification (RFID) device 150 includes a RFID sensor 1510 for detecting the radio-frequency signal, and a second mechanical connection interface 1530 which can be a thread or a snap-fit. The RFID sensor 1510 can be coupled to the second mechanical connection interface 1030 directly or by other mechanical components. In some embodiments, the RFID sensor 1510 is located at the external end of the accessory connection portion 230. The RFID device 150 can further includes a RFID cover 1520 for protecting the RFID sensor 1510. In some embodiments, the RFID cover 1520 fully covers the RFID sensor 1510 and part of the pressure vessel body 13.

In FIG. 27, the example accessory 22 is a light 160. The light 160 includes a light portion 1610, and a second mechanical connection interface 1630 which can be a thread or a snap-fit. The light portion 1610 a includes a light cover 1611, a circuit board 1613, a light circuit 1615, and a battery 1617. The light portion 1610 can be coupled to the second mechanical connection interface 1630 directly or by other mechanical components. In some embodiments, the accessory connection portion 230 extend within the pressure vessel body 13, e.g., through the first layers 133 without protruding from the external shape of the pressure vessel body 13. The example second mechanical connection interface 1630 is stepped, a smaller thread is configured to connect with the accessory connection portion 230 extending through the first layer 133 and a larger thread is configured to connect with a recess of the second layer 135. In some embodiments, when fully attached, the light portion 1610 is located at the external end of the accessory connection portion 230, and at least part of the light portion 1610 is located in the recess of the second layer 135. Such arrangement ensure the integrity of the pressured vessel body 13 and the attached light 160, and reduce the risk of the light 160 being struck. The light portion 1610a can further includes a cushion 1619 for protecting the light 160 from external impacts. In some embodiments the light 160 can be activated by means of a switch, by means of a motion sensor, by means of a sound sensor, or even remotely using a remote control of some sort.

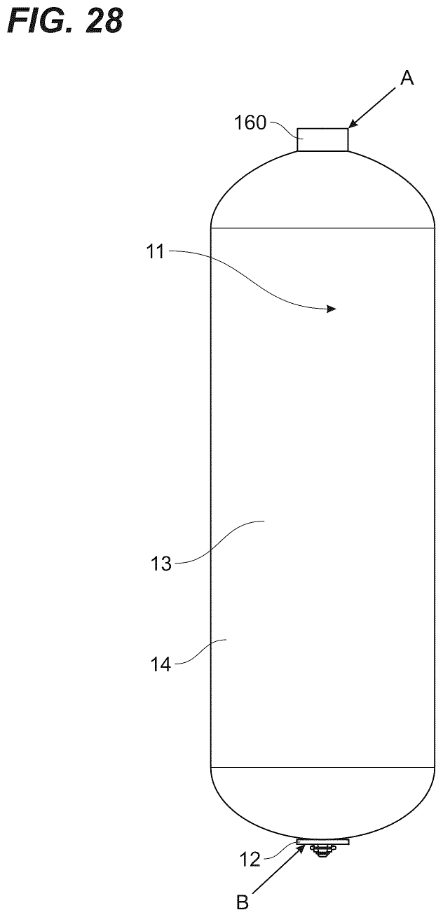

FIG. 28 is a schematic view of an example embodiment of a Self-Contained Breathing Apparatus with a light 160 attached. The Self-Contained Breathing Apparatus includes a neck 12 for supplying air, a pressured vessel body 13 for storing air, and an accessory attachment structure 20 for attaching the light 160. In order to preserve the integrity of rounded vessel shapes while providing secure and durable attachment interfaces for the light 160, a first light is attached to the pressured vessel body 13 via the accessory attachment structure 20 located at one rounded end of the pressured vessel body 13 at point A. In addition second light can be attached to the area adjacent to the neck at point B.

The various embodiments described above are provided by way of illustration only and should not be construed to limit the claims attached hereto. Those skilled in the art will readily recognize various modifications and changes that may be made without following the example embodiments and applications illustrated and described herein, and without departing from the following claims.

What is claimed is:

1. A pressure vessel comprising:
a pressure vessel body defining interior for containing a pressurized fluid, the pressure vessel body including a liner and at least a first layer that surrounds the liner, the first layer including a fiber-reinforced polymer; and
an accessory attachment structure coupled to the pressure vessel body, the accessory attachment structure including an accessory connection portion and an anchor portion, the anchor portion being secured between the liner and the first layer with the first layer overlapping the anchor portion, the accessory connection portion projecting outwardly from the anchor portion at least partially through the first layer.

2. The pressure vessel of claim 1, further comprising an accessory attached to the accessory connection portion.

3. The pressure vessel of claim 2, wherein the accessory is detachably attached to the accessory connection portion by a detachable mechanical connection, the detachable mechanical connection including a first mechanical connection interface integrated with the accessory connection portion and a second mechanical connection interface integrated with the accessory, wherein the first and second mechanical connection interfaces are configured to be detachably connected together.

4. The pressure vessel of claim 3, wherein the first mechanical connection interface includes first threads and the second mechanical connection interface includes second threads configured to mate with the first threads.

5. The pressure vessel of claim 2, wherein the accessory is a handle.

6. The pressure vessel of claim 2, wherein the accessory includes a bracket, a lanyard, a laser device, a container, a streamer, a molded base, a strap, a radio-frequency identification (RFID) device, a light, and a combination thereof.

7. The pressure vessel of claim 1, wherein the first layer is formed by a first resin- impregnated fiber-reinforced tow, the first resin-impregnated fiber-reinforced tow being wrapped around the liner and over the anchor portion of the accessory attachment surface.

8. The pressure vessel of claim 7, wherein the first resin-impregnated fiber-reinforced tow includes fiberglass, aramid fiber, carbon fibers, and a combination thereof.

9. The pressure vessel of claim 7, wherein the pressure vessel body includes a second layer formed by a second resin-impregnated fiber-reinforced tow, the second resin-impregnated fiber-reinforced tow being wrapped over the first layer and over the anchor portion of the accessory attachment surface.

10. The pressure vessel of claim 9, wherein one of the first and second layers includes fiberglass and the other of the first and second layers includes carbon fibers.

11. The pressure vessel of claim 1, wherein the pressure vessel is rated to accommodate an internal fluid pressure of at least 1000 pounds per square inch.

12. The pressure vessel of claim 1, wherein the accessory connection portion of the accessory attachment structure includes a first mechanical connection interface adapted for making a detachable connection with a second mechanical connection interface integrated with an accessory.

13. The pressure vessel of claim 1, wherein the accessory connection portion of the accessory attachment structure extends along an accessory connection axis, wherein the anchor portion of the accessory attachment structure is located at a base end of the accessory connection portion and projects radially outwardly from the accessory connection portion.

14. The pressure vessel of claim 13, wherein the anchor portion has a cross- dimension that is at least 1.5 times as large as a corresponding cross-dimension of the accessory connection portion.

15. The pressure vessel of claim 13, wherein the anchor portion of the accessory attachment structure has a circular outer shape when viewed from an orientation along the accessory connection axis of the accessory connection portion of the accessory attachment structure.

16. The pressure vessel of claim 13, wherein the anchor portion of the accessory attachment structure has a thickness measured in an orientation along the accessory connection axis of the accessory connection portion of the accessory attachment structure, and wherein the anchor portion is tapered such that the thickness reduces as the anchor portion extends radially away from the accessory connection axis of the accessory connection portion.

17. The pressure vessel of claim 16, wherein the anchor portion has a concave surface curved from a minor diameter at the accessory connection portion to a major outer diameter of the anchor portion.

18. The pressure vessel of claim 1, wherein the pressure vessel body is elongate along a pressure vessel axis and extends along the pressure vessel axis from a first end to a second end, wherein the pressure vessel body includes a cylindrical main body that extends between the first and second ends, wherein the first end includes a neck defining a tank port and the second end has a rounded dome shape, and wherein the accessory attachment structure is anchored to the pressure vessel body at the second end of the pressure vessel body.

19. The pressure vessel of claim 18, wherein the anchor portion of the accessory attachment structure is centered with respect to the pressure vessel axis.

20. The pressure vessel of claim 18, wherein the first layer is formed by a first resin- impregnated fiber-reinforced tow, the first resin-impregnated fiber-reinforced tow being wrapped in a longitudinal orientation around the first and second ends of the pressure vessel body, wherein the first resin-impregnated fiber-reinforced tow extends over the liner and over the anchor portion of the accessory attachment surface such that the anchor portion is secured between the liner and the first resin-impregnated fiber-reinforced tow.

21. The pressure vessel of claim 20, wherein the accessory connection portion of the accessory attachment structure extends along a connection portion axis that aligns with the pressure vessel axis, wherein the anchor portion of the accessory attachment structure is located at a base end of the accessory connection portion and projects radially outwardly from the accessory connection portion.

22. The pressure vessel of claim 21, wherein the anchor portion of the accessory attachment structure has a circular outer shape when viewed from an orientation along an accessory connection axis of the accessory connection portion of the accessory attachment structure.

23. The pressure vessel of claim 21, wherein the anchor portion of the accessory attachment structure has a thickness measured in an orientation along the connection portion axis of the accessory connection portion of the accessory attachment structure, and wherein the anchor portion is tapered such that the thickness reduces as the anchor portion extends radially away from an accessory connection axis of the accessory connection portion.

24. The pressure vessel of claim 23, wherein the anchor portion has a concave surface curved from a minor cross-dimension at the accessory connection portion to a major cross-dimension, and wherein the concave surface faces away from the liner.

25. The pressure vessel of claim 24, wherein the major cross-dimension of the anchor portion has a dimension that is 5-30 percent as large as an outer diameter of the cylindrical main body of the pressure vessel body.

26. The pressure vessel of claim 18, wherein the accessory connection portion of the accessory attachment structure includes a first mechanical connection interface adapted for making a detachable connection with a second mechanical connection interface integrated with an accessory.
